(19) United States
(12) Patent Application Publication
(10) Pub. No.: US 2011/0078312 A1
(43) Pub. Date: Mar. 31, 2011

(54) Method and system for monitoring incoming connection requests in a Peer-to-Peer network

(75) Inventors: Ivica Rimac, Tinton Falls, NJ (US); Volker Hilt, Middletown, NJ (US); Hassan Rasti Ekbatani, Eugene, OR (US)

(73) Assignee: ALCATEL-LUCENT

(21) Appl. No.: 12/585,980

(22) Filed: Sep. 30, 2009

(51) Int. Cl. G06F 15/16

(52) U.S. Cl. 709/227

(57) ABSTRACT

The present invention relates to a system and method for controlling peer-to-peer (P2P) traffic in an internet service provider (ISP) network. The system includes an ISP server configured to determine whether to accept or reject an incoming connection request to connect to a requested peer from a requesting peer in a P2P application. According to one embodiment, the ISP is configured to determine whether to accept or reject the incoming connection request based on current peer connectivity and cost of the incoming connection request. According to another embodiment, the ISP server determines whether to accept or reject the incoming connection request based on preference information available at the ISP server.

### BACKGROUND

Peer-to-Peer (P2P) applications use diverse connectivity between participants in a network and cumulative bandwidth of network participants rather than conventional centralized resources where a relatively low number of servers provide the core value to a service or application. P2P applications are typically used for sharing content files containing audio, video, or digital data, for example. Examples of P2P applications are BitTorent, FastTrack, eMule and Direct Connect, among others. P2P applications may generate a significant amount of traffic in internet service provider (ISP) networks.

A conventional method for reducing the impact of P2P applications on ISP networks is P2P traffic localization. P2P traffic localization enables ISPs to control the selection of neighbor peers while considering their policies and business relationships with other ISPs in order to manage and reduce traffic over costly communication links.

After a P2P application has made a neighbor selection, which may be guided by P2P localization algorithms of the ISP network, the P2P application establishes a connection to the selected peer. After the connection has been established, the connection is used by both peers (e.g., the requesting peer and the selected peer) in a bi-directional way to exchange traffic. It is irrelevant which peer has established the connection. Since a connection between two peers is utilized in both directions, the ISP networks of both peers (assuming the ISP network of the requesting peer is different from the ISP network of the selected peer) can apply their policies in the peer selection process. Without this capability, it is possible for one ISP to gain an unfair advantage over another ISP and to leverage a business agreement.

Conventional techniques for P2P traffic localization are based on the ISP network monitoring only the outgoing connection request. For example, the conventional techniques for outgoing P2P traffic localization include mechanisms in which the ISP networks either i) deploys an “oracle” which local peers contact for guidance, or ii) the ISP infrastructure communicates connection preferences to a P2P bootstrap node, as discussed below.

FIG. 1 illustrates a communication network 100 that deploys an oracle which local peers contact for guidance according to the first conventional approach. For instance, the network 100 includes an internet routing underlay 101. The internet routing underlay 101 includes a number of oracles 110, in which each oracle 110 is associated with a plurality of terminals 103 that are local to the associated oracle 110. The terminals 103 are candidate peers in a P2P application. In accordance with the first conventional approach, a new local peer 105 contacts a P2P bootstrap node (not shown) of the P2P application to receive a list of candidate peers (or potential neighbors) participating in the internet routing underlay 101. The P2P bootstrap may be a tracker in BitTorrent, for example. Next, the local peer 105 transmits the list of candidate peers to the oracle 110 associated with the local peer 105. The oracle 110 applies connection preferences by sorting the list of candidate peers. The oracle 110 returns the sorted list back to the requesting peer local peer 105. The local peer 105 uses the sorted list for initiating connections to preferred neighbors 104.

FIG. 2 illustrates a communication system 200 depicting an ISP infrastructure system 203 that communicates connection preferences to a P2P bootstrap node 202 according to the second conventional approach. In contrast to the first approach, a new local peer 201 contacts the P2P bootstrap node 202 and receives the already optimized list of candidate peers in return. For instance, before the P2P bootstrap node 202 responds to the request of the new local peer 201, the P2P bootstrap node 202 contacts the ISP infrastructure system 203 to inquire about the connection preferences associated with the ISP serving the new peer 201. The ISP infrastructure system 203 optimizes the potential neighbors before returning the optimized list of candidate peers to the requesting new local peer 201.

The first and second conventional approaches only cover outgoing connection requests—not incoming connection requests. For example, a new peer (e.g., requesting peer) may attempt to download music through a P2P application. In order for the new peer to download a song in a P2P application, the new peer would receive a list of candidate peers that have the requested song. The new peer would make an outgoing connection request to a candidate peer (e.g., requested peer) in order to establish a connection to the candidate peer to start downloading the requested song. According to the conventional approaches described above, the ISP monitors the outgoing connection requests to the candidate peers. In other words, the ISP will apply its preferences to the outgoing connection request. On the other side, when the request comes into the candidate peer (e.g., incoming connection request from the point of view of the candidate peer), the ISP does not monitor these requests. As such, P2P connections are bidirectional which result (on average) in only half of P2P connection being initiated by the requesting peer and the other half being established by accepting incoming connection requests. As a result, the preferences of the peer initiating the P2P connection are applied—not the preferences of the ISP of the requested peer. For the incoming connections to a requested peer, the ISP of the requested peer will have to accept the preferences of the ISP of the requesting peer. As a consequence, the ISP-friendliness objective is pursued only with half of the connections—e.g., the outgoing connection requests. In the malicious case, ISPs can gain an unfair advantage over other ISPs.

### SUMMARY

The present invention relates to a system and method for monitoring incoming connection requests in a P2P network.

The system includes an ISP server configured to determine whether to accept or reject an incoming connection request to connect to a requested peer from a requesting peer in a P2P application.

According to one embodiment, the ISP is configured to determine whether to accept or reject the incoming connection request based on current peer connectivity and cost of the incoming connection request.

The ISP server is configured to determine the cost of the incoming connection request by classifying the incoming connection request as one of a first class and a second class based on preference information available at the ISP server. The first class is associated with incurring costs and the second class is associated with not incurring costs. The ISP server is configured to determine the current peer connectivity based a number of existing peers connected to the P2P application.

According to another embodiment, the ISP server determines whether to accept or reject the incoming connection request based on preference information available at the ISP server. The preference information may be shared preference information of the ISP network of the requesting peer and the ISP network of the requested peer. Alternatively, the preference information may be preference information of the ISP network of the requested peer.

The method includes determining, by an ISP server, whether to accept or reject an incoming connection request to connect to a requested peer from a requesting peer in a P2P application.

According one embodiment, the determining step determines whether to accept or reject the incoming connection request based on current peer connectivity and cost of the incoming connection request. In this embodiment, the method further includes classifying the incoming connection request as one of a first class and a second class based on preference information available at the ISP server to determine the cost of the incoming connection request. The first class is associated with incurring costs and the second class is associated with not incurring costs.

The method further includes determining the current peer connectivity based a number of existing peers connected to the P2P application.

According to another embodiment, determining step determines whether to accept or reject the incoming connection request based on preference information available at the ISP server. The preference information may be shared preference information of the ISP network of the requesting peer and the ISP network of the requested peer. Alternatively, the preference information may be preference information of the ISP network of the requested peer.

According to another embodiment, the method includes determining, by a requested peer, whether to accept or reject an incoming connection request from a requesting peer to connect to the requested peer in a P2P application. The method includes receiving preference information from an ISP network associated with the requested peer.

According to one embodiment, the determining step determines whether to accept or reject the incoming connection request based on current peer connectivity and cost of the incoming connection request. In this embodiment, the method further includes classifying the incoming connection request as one of a first class and a second class based on preference information to determine the cost of the incoming connection request. The first class is associated with incurring costs and the second class is associated with not incurring costs. If an IP identifier of the requesting peer is not listed on the preference information, the incoming connection request is associated with the first class.

The method further includes determining the current peer connectivity based a number of existing peers connected to the P2P application.

Example embodiments of the present invention may also include an ISP server for controlling P2P traffic between at least first and second peers in a communication network. The ISP server may include a memory for storing preference information concerning costs relating to the P2P traffic, a processing unit configured to accept or reject an incoming connection request, from the first peer, for connecting the first peer to the second peer in a P2P application based on the preference information, and an interface for communicating signals to at least one of the first and second peers.

The memory may further store a decision calculator configured to determine whether to accept or reject the incoming connection request based on current peer connectivity and cost of the incoming connection request. The decision calculator is configured to determine the cost of the incoming connection request by classifying the incoming connection request as one of a first class and a second class based on the preference information. The first class is associated with incurring costs and the second class is associated with not incurring costs. The decision calculator is configured to determine the current peer connectivity based a number of existing peers connected to the P2P application.

The preference information may be preference information of the ISP network of the second peer. Alternatively, the preference information may be shared preference information of the ISP network of the first peer and the ISP network of the second peer.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present invention, and wherein:

FIG. 1 illustrates a communication network that deploys an oracle which local peers contact for guidance according to the first conventional approach;

FIG. 2 illustrates a communication system depicting an ISP infrastructure system that communicates preferences to a P2P bootstrap node according to the second conventional approach;

FIG. 3 illustrates a system and method for controlling P2P traffic in an ISP network according to an embodiment of the present invention;

FIG. 4 illustrates an embodiment of the ISP server according to the present invention; and

FIG. 5 illustrates a graph illustrating the probability of accepting incoming connection requests based on the current peer connectivity and the cost of the incoming connection request according to an embodiment of the present invention.

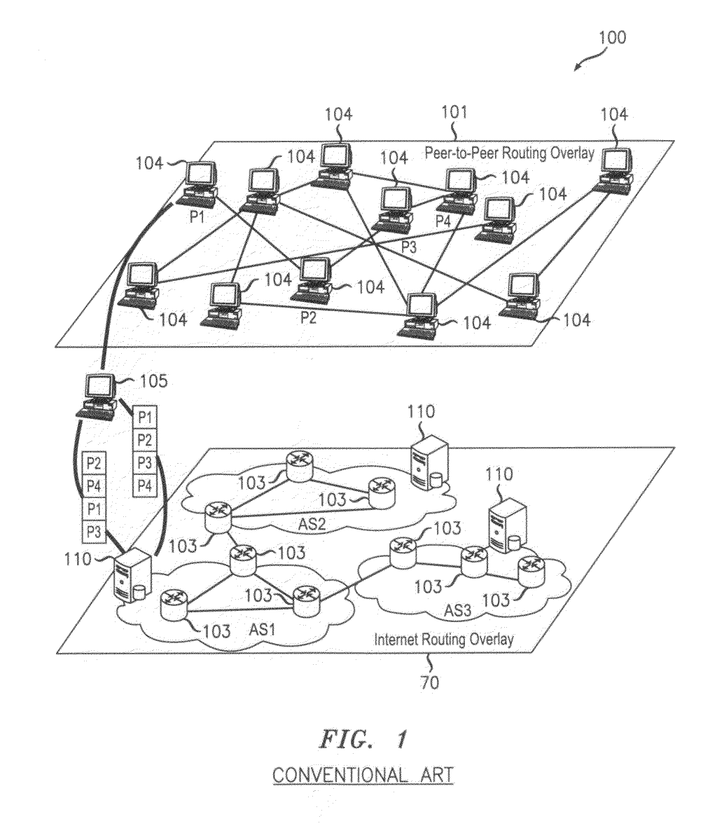

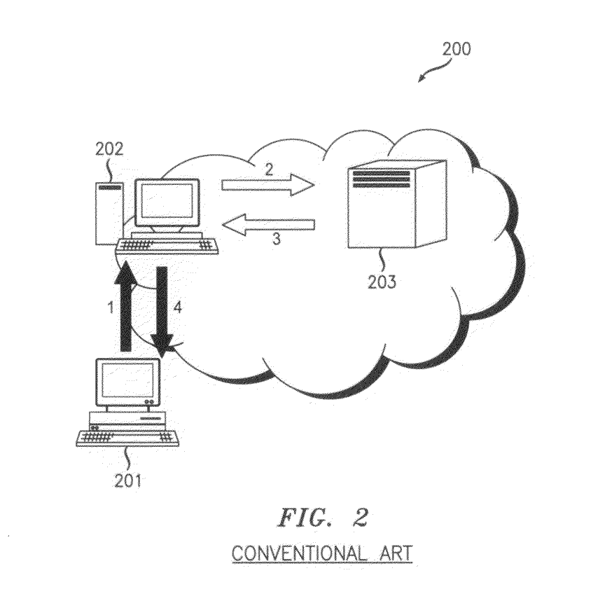

### DETAILED DESCRIPTION OF EXAMPLE EMBODIMENTS

Various example embodiments of the present invention will now be described more fully with reference to the accompanying drawings in which some example embodiments of the invention are shown. Like numbers refer to like elements throughout the description of the figures.

As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Example embodiments of the prevent invention relate to a system and method for monitoring incoming connection requests within an internet service provider (ISP) network for peer-to-peer (P2P) applications. For example, the system and method of the prevent invention overcomes the disadvantageous of the convention approaches by monitoring incoming connection requests for P2P applications in addition to the outgoing connections requests as described with reference to the first and second convention approaches.

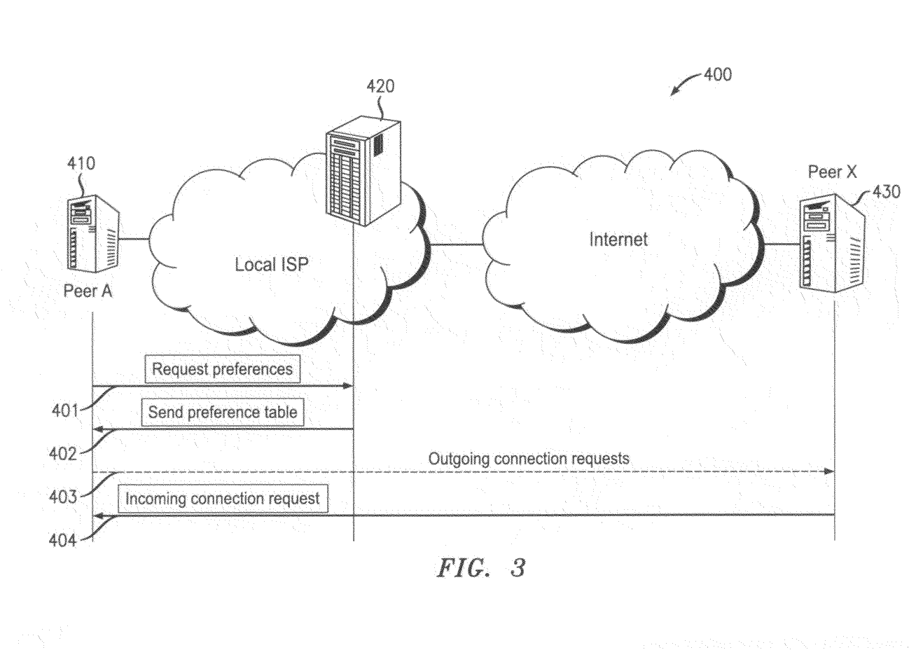

FIG. 3 illustrates a system and method for controlling P2P traffic in an ISP network according to the present invention. The system 400 includes Peer A 410, an ISP server 420, and Peer X 430. The ISP server 420 may be located within an infrastructure of a service provider. Peer A 410 and Peer X 430 may be any type of system configured to operate a P2P application such as a personal computer, wireless phone or any other similar device.

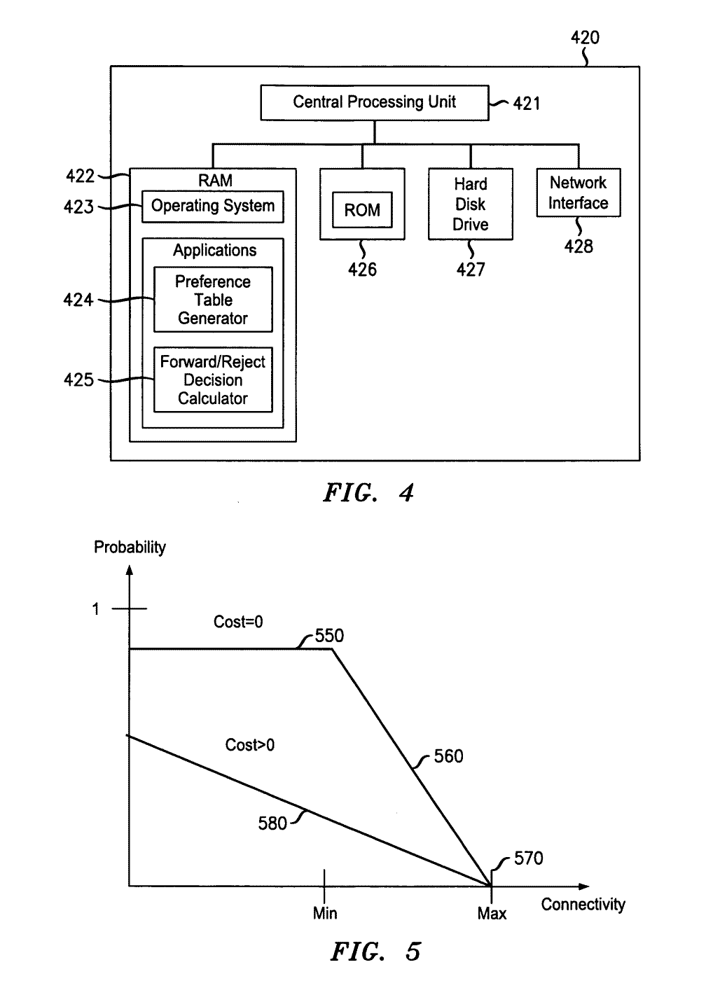

FIG. 4 illustrates an embodiment of the ISP server 420 according to the present invention. The ISP server 420 includes a central processing unit (CPU) 421, random access memory (RAM) 422, read only memory (ROM) 426, a hard disk drive 427, and a network interface 428. The ISP server 420 may also include other components other than shown on FIG. 4 that are well known to one skilled in the art. The CPU 421, the RAM 422, the ROM 426, the hard disk drive 427, and the network interface 428 communicate with each other via a bus. The hard disk drive 427 operates in a manner which is well known to one skilled in the art.

The RAM 422 may store an operating system 423 providing instructions for the CPU 421 to carry out operations of the ISP server 420. Any general-purpose operating system may be employed. The network interface 428 allows the CPU 421 to communicate with the Internet, or some other communications network, which are constructed for use with various communication protocols including the TCP/IP protocol. The network interface unit 428 may include transceiver(s), transceiving device(s), and/or network interface card(s) (NICs), for example.

Also, the RAM 422 may include one or more data storages, which can be utilized by the ISP server 420 to store, among other things, applications, as well as database information, for example. For instance, the RAM 422 may store a preference table generator 424, which is configured to generate and/or store preference information. This feature is further explained below. In addition, the RAM 422 may store a forward/reject decision calculator 425 in order to determine whether connection requests are accepted or rejected. This feature is also further explained below.

Referring back to FIG. 3, as shown by 401, Peer A 410 requests preference information from the ISP server 420 for P2P connections for Peer A 410. For example, the request is sent to the CPU 421 in the ISP server 420 through the network interface 428 pursuant to a pre-agreed upon protocol. The CPU 421 communicates with the preference table generator 424 to obtain the preference information being stored and/or generated by the preference table generator 424. The preference information may include a table of IP identifiers and the associated cost. The IP identifiers may be IP prefixes of corresponding peers, for example. The IP identifiers are associated with costs. The costs are charges imposed on the ISP by a transit network provider for the potential data being transferred after the connection request has been accepted.

As shown by 402, the CPU 421 communicates this preference information to Peer A 410. For example, the preference information is transmitted by the CPU 421 to Peer A through the network interface 428 according to the agreed upon protocol. The preference information may be used for both locally initiated connection attempts as well as incoming connection requests (e.g., see 403 and 404 in FIG. 3).

According to an embodiment of the present invention, and as shown by 403, Peer A 410 transmits an outgoing connection request within a P2P application to Peer X 430. For instance, Peer A 410 initially contacts a P2P bootstrap node (not shown) to announce itself and request a list of candidate peers. The list of candidate peers may include peer identifiers such as peer IDs and IP addresses, for example. Examples of a bootstrap node include but are not limited to a centralized Tracker used in BitTorrent-like P2P networks. For example, Peer A 410 or Peer X 430 would obtain the Tracker address by downloading a so-called torrent file from a web site. This file at least includes the address of the Tracker bootstrap node. Another example for a bootstrap node is a regular peer such as Peer A 410 or Peer X 430. For example, when the P2P network is using a distributed hash table (DHT) instead of a centralized server, the bootstrap node is the peer. A peer joining the P2P network may try to connect to peers in which the joining peer has discovered during previous sessions to join the DHT. The joining peer may then obtain a list of candidate peers using the DHT.

Once Peer A 410 has received the random candidate list containing peer IDs and IP addresses, Peer A 410 would sort the random candidate list using the preference information previously received from the CPU 421 of the ISP server 420.

Referring to FIG. 3, as shown by 404, Peer A 410 may receive an incoming connection request from Peer X 430 to connect to Peer A 410 in a P2P application. The CPU 421 of the ISP server 420 monitors and intercepts the incoming P2P connection request to Peer A 410.

After the CPU 421 of the ISP server 420 intercepts the incoming P2P connection request, the CPU 421 of the ISP server 420 either accepts (forward) or rejects the incoming connection request. For example, after the CPU 421 intercepts the incoming P2P connection request, the CPU 421 communicates with the forward/reject decision calculator 425. The forward/reject decision calculator 425 determines whether to forward or reject the incoming connection request. After this determination is made, the forward/reject decision calculator 425 provides instructions for the CPU 421 to either forward or reject the incoming connection request.

According to one embodiment, the forward/reject decision decision calculator 425 makes this determination by calculating a probability of acceptance based on cost of the incoming connection and current peer connectivity, which is described below.

The cost of the incoming connection request is based on the preference information available and/or stored at the preference table generator 424 of the RAM 422. The preference information includes IP identifiers and associated costs. According to an embodiment, the forward/reject decision calculator 425 is configured to classify the incoming connection request as one of a first class and a second class based on the preference information available stored on the RAM 422 of the ISP server 420. The forward/reject decision calculator 425 communicates with the preference table generator 424 in order to obtain the preference information for determining cost of the incoming connection request. For example, if the incoming connection request is associated with incurring cost (cost>0) for the ISP, the incoming connection request is classified according to the first class. If the incoming connection request is associated with not incurring cost (cost=0) for the ISP, the incoming connection request is classified according to the second class.

If the IP identifier of the requesting peer is not listed in the preference information, the cost of the incoming connection is assumed to be the highest cost and associated with the first class. For example, if the IP prefix of Peer X 430 is not listed in the preference information, the requested service of peer X 430 is assumed to be the highest cost, and classified according to the first class.

Once Peer X 430 has been classified, the probability of accepting the connection request of Peer X 430 will then depend on the current connectivity. For example, the CPU 421 determines the current peer connectivity based on the current peer connectivity of the requested peer. For instance, the CPU 421 determines a number of existing peers connected to the P2P application. The CPU 421 may track this information by monitoring the accepted requests per class, for example. The class may include accepted requests by an ISP and/or an IP prefix, among others, for example. For instance, the CPU 421 may track the number of accepted requests by the ISP server 420. This determines the current connectivity of the ISP server 420 to the P2P application. Also, the CPU 421 may determine the number of accepted requests according to an IP prefix such as the IP prefix of Peer X 430. The forward/reject decision calculator 425 stores this information determined by the CPU 421.

FIG. 5 illustrates a graph illustrating the probability of accepting incoming connection requests based on the current peer connectivity and the cost of the incoming connection request according to an embodiment of the present invention. In this example, if Peer X 430 has been classified as belonging to the second class (cost=0) and Peer A 410 has fewer than a minimum number of connections to other peers, the CPU 421 will accept and/or forward the connection request with a relatively high degree of probability, as shown by 550. If Peer X 430 has been classified as belonging to the second class (cost=0) and Peer A 410 has greater than a minimum number of connections to other peers, the probability of accepting the incoming request decreases, as shown by 560. In the case where Peer A 410 has already established the maximum number of connections, all connections requests will be dropped, as shown by 570. If Peer X 430 has been classified as belonging to the first class (cost>0), the probability of accepting the incoming connection request gradually decreases as the number of connections to other peers increases, as shown by 580.

According to another embodiment, the CPU 421 may either accept or reject an incoming connection request to connect to a requested peer in a P2P application according to the preference information available at the preference table generator 424 in the RAM 422. The preference information may be the shared preferences of the ISP network that originated the incoming connection request and the ISP network receiving the incoming connection request (e.g., the requested peer). For instance, the ISP server 420 may apply preferences according to an existing agreement between the ISP associated with Peer A 410 and the ISP associated with Peer X 430 for incoming connection requests.

For example, if the ISP associated with the requesting peer and the ISP associated with the requested peer have a peering agreement that allows each party to transmit data to the other party free of charge, the ISP server 420 associates no cost for the incoming connection request. Therefore, the ISP server 420 associates a higher preference to the connections passing over this peering link, and will operate according to the shared preferences of the two ISPs.

In addition, the CPU 421 may accept or reject an incoming connection request to connect to a requested peer in a P2P application according to the preference of the ISP network receiving the incoming connection requests. For example, the ISP server 420 would apply its own preferences in regards to the incoming connection requests according to 404 in FIG. 3.

For example, in the case that the local ISP is a customer of the ISP associated with Peer X 430, the local ISP will have to pay for the traffic passing through the communication link between the two ISPs. However, for the remote ISP (associated with Peer X 430), this traffic will not be costly. Therefore, if the ISP server 420 is configured to operate according to the preferences of the local ISP, the ISP server 420 will probably reject incoming connections from the remote ISP associated with peer X against the preferences of the remote ISP.

According to yet another embodiment of the present invention, referring to 404 of FIG. 3, when Peer A 410 (e.g., requested peer) receives an incoming request from Peer X 430 (e.g., requesting peer), Peer A 410 determines whether to accept or reject the incoming request according to a number of parameters. This determination is similar to the operation described above with reference to the forward/reject decision calculator 425 of the ISP server 420 except this determination is performed at Peer A 410.

For example, Peer A 410 may calculate a probability of acceptance based on current connectivity of Peer A 410 and the cost of the incoming connection.

The cost of the incoming connection request is based on the preference information previously received by Peer A 410 according to 402 in FIG. 3. Using the preference information, Peer A 410 classifies the incoming connection request into one of a first class and a second class based on the preference information. Similar to the operation described above with reference to the forward/reject decision calculator 425 of the ISP server 420, if the incoming connection request is associated with incurring cost (cost>0) for the ISP, the incoming connection request is classified according to the first class. Also, if the incoming connection request is associated with not incurring cost (cost=0) for the ISP, the incoming connection request is classified according to the second class.

If the IP identifier of the requesting peer (e.g., Peer X 430) is not listed on the preference information, the cost of the incoming connection is assumed to be the highest cost and associated with the first class. For example, if the IP prefix of Peer X 430 is not listed on the preference information received according to 402 in FIG. 3, the requested service of peer X 430 is assumed to be the highest cost and associated with the first class.

Once Peer X 430 has been classified, the probability of accepting the connection request of Peer X 430 will then depend on the current connectivity. Peer A 410 determines the current peer connectivity based on the current peer connectivity of the requested peer. The current peer connectivity is determined by the number of existing peers connected to the P2P application.

Referring to FIG. 5 and as discussed above, if Peer X 430 has been classified as belonging to the second class (cost=0) and Peer A 410 has fewer than a minimum number of connections to other peers, Peer A 410 will accept the connection request with a relatively high degree of probability, as shown by 550. If Peer X 430 has been classified as belonging to the second class (cost=0) and Peer A 410 has greater than a minimum number of connections to other peers, the probability of accepting the incoming request decreases, as shown by 560. In the case where Peer A 410 has already established the maximum number of connections, all connections requests will be dropped, as shown by 570. If Peer X 430 has been classified as belonging to the first class (cost>0), the probability of accepting the incoming connection request gradually decreases as the number of connections to other peers increases, as shown by 580.

Variations of the example embodiments of the present invention are not to be regarded as a departure from the spirit and scope of the example embodiments of the invention, and all such variations as would be apparent to one skilled in the art are intended to be included within the scope of this invention.

What is claimed is:

1. A system for controlling peer-to-peer (P2P) traffic in an internet service provider (ISP) network, the system comprising:
an ISP server configured to determine whether to accept or reject an incoming connection request to connect to a requested peer from a requesting peer in a P2P application.

2. The system of claim 1, wherein the ISP is configured to determine whether to accept or reject the incoming connection request based on current peer connectivity and cost of the incoming connection request.

3. The system of claim 2, wherein the ISP server is configured to determine the cost of the incoming connection request by classifying the incoming connection request as one of a first class and a second class based on preference information available at the ISP server, the first class being associated with incurring costs, the second class being associated with not incurring costs.

4. The system of claim 2, wherein the ISP server is configured to determine the current peer connectivity based a number of existing peers connected to the P2P application.

5. The system of claim 1, wherein the ISP server determines whether to accept or reject the incoming connection request based on preference information available at the ISP server.

6. The system of claim 5, wherein the preference information is shared preference information of the ISP network of the requesting peer and the ISP network of the requested peer.

7. The system of claim 5, wherein the preference information is preference information of the ISP network of the requested peer.

8. A method for controlling peer-to-peer (P2P) traffic in an internet service provider (ISP) network, the method comprising:
determining, by an ISP server, whether to accept or reject an incoming connection request to connect to a requested peer from a requesting peer in a P2P application.

9. The method of claim 8, wherein the determining step determines whether to accept or reject the incoming connection request based on current peer connectivity and cost of the incoming connection request.

10. The method of claim 9, further comprising:
classifying the incoming connection request as one of a first class and a second class based on preference information available at the ISP server to determine the cost of the incoming connection request, the first class being associated with incurring costs, the second class being associated with not incurring costs.

11. The method of claim 9, further comprising:
determining the current peer connectivity based a number of existing peers connected to the P2P application.

12. The method of claim 8, wherein the determining step determines whether to accept or reject the incoming connection request based on preference information available at the ISP server.

13. The method of claim 12, wherein the preference information is shared preference information of the ISP network of the requesting peer and the ISP network of the requested peer.

14. The method of claim 12, wherein the preference information is preference information of the ISP network of the requested peer.

15. A method for controlling peer-to-peer (P2P) traffic in an internet service provider (ISP) network, the method comprising:
determining, by a requested peer, whether to accept or reject an incoming connection request from a requesting peer to connect to the requested peer in a P2P application.

16. The method of claim 15, further comprising:
receiving preference information from an ISP network associated with the requested peer.

17. The method of claim 15, wherein the determining step determines whether to accept or reject the incoming connection request based on current peer connectivity and cost of the incoming connection request.

18. The method of claim 17, further comprising:
classifying the incoming connection request as one of a first class and a second class based on preference information to determine the cost of the incoming connection request, the first class being associated with incurring costs, the second class being associated with not incurring costs.

19. The method of claim 18, wherein if an IP identifier of the requesting peer is not listed on the preference information, the incoming connection request is associated with the first class.

20. The method of claim 17, further comprising:
determining the current peer connectivity based a number of existing peers connected to the P2P application.

21. An internet service provider (ISP) server for controlling peer-to-peer (P2P) traffic between at least first and second peers in a communication network, the ISP server comprising:
a memory for storing preference information concerning costs relating to the P2P traffic;
a processing unit configured to accept or reject an incoming connection request, from the first peer, for connecting the first peer to the second peer in a P2P application based on the preference information.
an interface for communicating signals to at least one of the first and second peers.

22. The ISP server of claim 21, wherein the memory further stores a decision calculator configured to determine whether to accept or reject the incoming connection request based on current peer connectivity and cost of the incoming connection request.

23. The ISP server of claim 22, wherein the decision calculator is configured to determine the cost of the incoming connection request by classifying the incoming connection request as one of a first class and a second class based on the preference information, the first class being associated with incurring costs, the second class being associated with not incurring costs.

24. The ISP server of claim 22, wherein the decision calculator is configured to determine the current peer connectivity based a number of existing peers connected to the P2P application.

25. The ISP server of claim 21, wherein the preference information is preference information of the ISP network of the second peer.

26. The ISP server of claim 21, wherein the preference information is shared preference information of the ISP network of the first peer and the ISP network of the second peer.
